(19) United States
(12) Patent Application Publication
(10) Pub. No.: US 2026/0062848 A1
(43) Pub. Date: Mar. 5, 2026

(54) BALANCED AND UNBALANCED LOAD DETECTION

(71) Applicant: NXP USA, Inc., Austin, TX (US)

(72) Inventors: Libor Prokop, Roznov (CZ); Jaroslav Lepka, FRENSTAT POD RADHOSTEM (CZ)

(21) Appl. No.: 19/304,020

(22) Filed: Aug. 19, 2025

(30) Foreign Application Priority Data
Aug. 30, 2024 (EP) 24197476.5

(51) Int. Cl. D06F 33/48; D06F 34/16; D06F 37/30; D06F 103/24; D06F 103/26; D06F 103/46; D06F 105/48; H02P 23/14

(52) U.S. Cl. CPC D06F 33/48; D06F 34/16; D06F 37/304; H02P 23/14; D06F 2103/24; D06F 2103/26; D06F 2103/46; D06F 2105/48

(57) ABSTRACT

Balanced and unbalanced loads are detected in a rotary motor control application such as a washing machine. A rotary machine includes a drum containing a plurality of load portions and is driven for rotation about a rotation axis by a motor. A method of estimating loads includes estimating an unbalanced load by measuring a rotational speed of the drum during a first time period over a first complete rotation of the drum while the motor is driven under constant torque control, determining a maximum speed angle during the first time period, measuring torque and rotational speed during a second time period while the motor is driven under constant torque control, and calculating an unbalanced load from measurements of torque and rotational speed over the second time period and a difference in rotational speed over first and second halves of the second time period.

### FIELD

The disclosure relates to detecting unbalanced and balanced loads in a rotary motor control application such as a washing machine.

### BACKGROUND

Operational safety of rotary motor control applications, for example in washing machines, requires detection of unbalanced loads during rotation. In a washing machine, an unbalanced load is caused by an uneven distribution of laundry inside the washing machine drum. When the unbalanced load increases above a certain limit, it can impact on the mechanical behaviour of the system, causing mechanical vibrations. In extreme cases this may result in the drum contacting the chassis, the washing machine moving and, in the worst case, damage to the machine, particularly at high drum speeds. The unbalanced load therefore needs to be measured and, if necessary, corrected before running the machine at high speeds. Another task for a washing machine is measurement of the total balanced and unbalanced weight of laundry inside the drum during operation.

Especially with increasing washer drum sizes, a reliable measure of unbalanced load is necessary. Detecting and correcting for an unbalanced load optimizes the washing cycle, saves money and improves operational safety.

### SUMMARY

According to a first aspect there is provided a method of estimating loads in a rotary machine comprising a drum containing a plurality of load portions and driven for rotation about a rotation axis by a motor, the method comprising: estimating an unbalanced load by:
i) measuring a rotational speed of the drum during a first time period over a first complete rotation of the drum while the motor is driven under constant torque control;
ii) determining a maximum speed angle during the first time period as a rotational angle of the drum over the first time period at which the rotational speed of the drum is a maximum;
iii) measuring torque and rotational speed during a second time period over a second complete rotation of the drum starting at the maximum speed angle offset by a predetermined advance angle while the motor is driven under constant torque control;
iv) calculating an estimated unbalanced load of the drum from measurements of torque and rotational speed over the second time period and a difference in rotational speed over first and second halves of the second time period.

The method enables calculation of an unbalanced load for a rotary machine using measurements of torque and speed control quantities during operation of the rotary machine.

The estimated unbalanced load Δm may be calculated from:

$$Δ m = \frac{{t}_{s}}{r \cdot g \cdot ( - 2 )} \cdot {ω}_{01} \cdot {ω}_{02} \cdot \frac{{Δ}_{180} {\hat{ω}}_{ε {A}_{2}} \cdot {S}_{180 T {a}_{1}} - {Δ}_{180} {\hat{ω}}_{ε {A}_{1}} \cdot {S}_{180 T {a}_{2}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$

where tₛ is a measurement sampling period, r is a radius of the drum, g is a gravitational acceleration, ω₀₁ is a rotational speed at the start of the second time period, ω₀₂ is a rotational speed at the end of the second time period, S_{180Ta}_{₁} is a sum of torque samples over the first half of the second time period, S_{180Ta}_{₂} is a sum of torque samples over the second half of the second time period, Δ₁₈₀\hat{ω}_{εA}_{₂} is a difference in rotational speed over the first half of the second time period and Δ₁₈₀\hat{ω}_{εA}_{₂} is a difference in rotational speed over the second half of the second time period.

The predetermined advance angle α_{advanced} may be calculated as:

$${α}_{advanced} = α ( Speed Max ) - {α}_{11} ( 0 ) = \frac{{N}_{b} \cdot {t}_{s} \cdot {ω}_{0 x}}{2}$$

where α(Speed Max) is the maximum speed angle, α₁₁(0) is the rotation angle at the start of the second time period, N_{b} is a number of samples over the first half of the second time period, ω₀ₓ is the rotational speed at the start of the second time period.

The method may further comprise calculating an estimated balanced load m from:

$$m = \frac{{t}_{s}}{{r}^{2}} \cdot \frac{{ω}_{02} \cdot {S}_{180 T {a}_{2}} - {ω}_{01} \cdot {S}_{180 T {a}_{1}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$

The method may further comprise calculating an estimated balanced load by:
i) measuring a torque during a third time period over a third complete rotation of the drum while the motor is driven under constant speed control to determine an average friction torque;
ii) measuring the torque and a rotation speed of the drum during a fourth time period over a fourth complete rotation of the drum while the motor is driven under constant acceleration control to determine an average acceleration torque;
iii) subtracting the average friction torque from the average acceleration torque to obtain a corrected average acceleration torque; and
iv) calculating the estimated balanced load of the drum from the corrected acceleration torque, a difference in rotation speed over the second time period and a radius of the drum.

The estimated balanced load m of the drum may be calculated from:

$$m ≅ \frac{{t}_{s}}{{r}^{2}} \cdot \frac{{S}_{360 Tmd {ε0}_{1}}}{{Δ}_{360} {ω}_{ε {0}_{1}}}$$

where tₛ is a measurement sampling period, r is the radius of the drum, S_{360 Tmdε0}_{₁} is a sum of measured torque samples over the fourth time period and Δ₃₆₀ω_{ε0}_{₁} is the difference in rotation speed over the fourth time period.

Measuring the torque may comprise measuring an electric current through the motor and converting the measured electric current to a measure of torque, the torque optionally being measured as a linear function of the measured electric current.

The rotational speed and position may be derived from a rotational sensor on the rotor.

According to a second aspect there is provided a motor controller for a rotary machine comprising a drum for containing a plurality of load portions driven for rotation about a rotation axis by a motor, the motor controller being configured to estimate an unbalanced load on the drum by:
i) measuring a rotational speed of the drum during a first time period over a first complete rotation of the drum while the motor is driven under constant torque control;
ii) determining a maximum speed angle during the first time period as a rotational angle of the drum over the first time period at which the rotational speed of the drum is a maximum;
iii) measuring torque and rotational speed during a second time period over a second complete rotation of the drum starting at the maximum speed angle offset by a predetermined advance angle while the motor is driven under constant torque control;
iv) calculating an estimated unbalanced load of the drum from measurements of torque and rotational speed over the second time period and a difference in rotational speed over first and second halves of the second time period.

The estimated unbalanced load Δm may be calculated from:

$$Δ m = \frac{{t}_{s}}{r \cdot g \cdot ( - 2 )} \cdot {ω}_{01} \cdot {ω}_{02} \cdot \frac{{Δ}_{180} {\hat{ω}}_{ε {A}_{2}} \cdot {S}_{180 T {a}_{1}} - {Δ}_{180} {\hat{ω}}_{ε {A}_{1}} \cdot {S}_{180 T {a}_{2}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$

where tₛ is a measurement sampling period, r is a radius of the drum (101), g is a gravitational acceleration, ω₀₁ is a rotational speed at the start of the second time period, ω₀₂ is a rotational speed at the end of the second time period, S_{180Ta}_{₁} is a sum of torque samples over the first half of the second time period, S_{180Ta}_{₂} is a sum of torque samples over the second half of the second time period, Δ₁₈₀\hat{ω}_{εA}_{₁} is a difference in rotational speed over the first half of the second time period and Δ₁₈₀\hat{ω}_{εA}_{₂} is a difference in rotational speed over the second half of the second time period.

The predetermined advance angle α_{advanced} may be calculated as:

$${α}_{advanced} = α ( Speed Max ) - {α}_{11} ( 0 ) = \frac{{N}_{b} \cdot {t}_{s} \cdot {ω}_{0 x}}{2}$$

where α(Speed Max) is the maximum speed angle, α₁₁(0) is the rotation angle at the start of the second time period, N_{b} is a number of samples over the first half of the second time period, ω₀ₓ is the rotational speed at the start of the second time period.
wherein the motor controller is further configured to calculate an estimated balanced load m from:

$$m = \frac{{t}_{s}}{{r}^{2}} \cdot \frac{{ω}_{02} \cdot {S}_{180 T {a}_{2}} - {ω}_{01} \cdot {S}_{180 T {a}_{1}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$

The motor controller may be further configured to calculate an estimated balanced load by:
i) measuring a torque during a third time period over a third complete rotation of the drum while the motor is driven under constant speed control to determine an average friction torque;
ii) measuring the torque and a rotation speed of the drum during a fourth time period over a fourth complete rotation of the drum while the motor is driven under constant acceleration control to determine an average acceleration torque;
iii) subtracting the average friction torque from the average acceleration torque to obtain a corrected average acceleration torque; and
iv) calculating the estimated balanced load of the drum from the corrected acceleration torque, a difference in rotation speed over the second time period and a radius of the drum.

The estimated balanced load m of the drum may be calculated from:

$$m ≅ \frac{{t}_{s}}{{r}^{2}} \cdot \frac{{S}_{360 Tmd {ε0}_{1}}}{{Δ}_{360} {ω}_{ε {0}_{1}}}$$

where tₛ is a measurement sampling period, r is the radius of the drum, S_{360 Tmdε0}_{₁} is a sum of measured torque samples over the fourth time period and Δ₃₆₀ω_{ε0}_{₁} is the difference in rotation speed over the fourth time period.

According to a third aspect there is provided a rotary machine comprising a drum, an electric motor and a motor controller according to the second aspect, the drum connected to be driven about a horizontal axis by the electric motor under control of the motor controller. The rotary machine may be a washing machine.

According to a fourth aspect there is provided a computer program comprising instructions to cause a motor controller for a rotary machine to perform the method according to the first aspect.

There may be provided a computer program, which when run on a computer, causes the computer to configure a controller disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software implementation may be an assembly program.

The computer program may be provided on a non-transitory computer readable medium, which may be a physical computer readable medium, such as a disc or a memory device, or may be embodied as a transient signal. Such a transient signal may be a network download, including an internet download.

These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which:

FIG. 1a is a schematic diagram of a washer drum with a balanced load;

FIG. 1b is a schematic diagram of a washer drum with an unbalanced load;

FIG. 2 is a schematic diagram of a washer drum with an equivalent unbalanced load;

FIG. 3 is a schematic plot of speed, torque and drum angle as a function of rotation angle during a washer drum balanced weight detection procedure;

FIG. 4 is a schematic plot of speed, torque and drum angle as a function of rotation angle during a washer drum unbalanced weight detection procedure;

FIG. 5 is a further schematic plot of speed, torque and drum angle as a function of rotation angle during a washer drum unbalanced weight detection procedure;

FIGS. 6a and 6b are schematic diagrams illustrating an example process for determining balanced and unbalanced loads; and

FIG. 7 is a schematic diagram of an assembly comprising a drum connected to an electric motor that is driven by a motor controller.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

### Definitions

The following terms or variables used throughout the detailed description are listed in Table 1 below, together with their corresponding meaning.

TABLE 1
Terms/variables used in the specification.

| Term | Meaning |
|---|---|
| B = r · g(sin α₂ − | Constant |
| sin α₁) = r · g · ΔSin | |
| Δm_{unbalanced} | Unbalanced mass |
| Δm | Balanced mass |
| Δ_{(α}_{₁}_{α}_{₃}₎ω_{ε0} | Angular speed difference between drum (rotor) |
| | angle α₁ and α₂ positions |
| Δ₁₈₀\hat{ω}_{εA}_{₂} | Estimated angular speed difference of |
| | alternating acceleration between drum (rotor) |
| | angle α and α + 180 positions |
| ε | Angular acceleration |
| Δ_{(α}_{₁}_{α}_{₂}₎ t = t_{α2} − | Time difference between drum (rotor) angles |
| t_{α1} | α₁, α₂ positions |
| ΔSin = Sin(α₂) − | Sine function difference between drum (rotor) |
| Sin(α₁) | position angles α₁ α₂ |
| F_{c} | Centrifugal force (N) |
| F_{g} | Gravitational force (N) |
| g | Gravitational acceleration (ms⁻²) |
| Int_{TAα1α2} | Integral of alternating torque samples per drum |
| | (rotor) rotation interval from α₁ to α₂ |
| J | Mechanical inertia with radius rᵢ |
| mᵢ | Mass element i |
| mᵣ, m | Balanced mass at radius r from rotating axis |
| N₃₆₀ | Number of samples per 360 degree drum (rotor) |
| | angle |
| r | Drum radius |
| rᵢ | Radius of element i from rotational axis |
| S_{360 T} | Sum of torque samples per 360 degree drum |
| | (rotor) rotation |
| S_{180 Tα}(α₍ₖ₎) | Sum of alternating torque (average subtracted) |
| | samples per 180 degree drum (rotor) rotation at |
| | α₍ₖ₎ step with iteration |
| S_{180 Tα} | Sum of alternating torque (average subtracted) |
| | samples per 180 degree drum (rotor) rotation |
| tₛ | Sampling time |
| T_{AVG} | Average torque |
| T_{AVG0} | Average torque at zero acceleration speed |
| | control |
| T_{g} | Gravitation response torque |
| T_{d} | Dynamic torque |
| T_{f} | Frictional torque |
| Tₘ | Motor torque |
| T_{mD} | Motor torque direct component |
| T_{mDf} | Motor torque direct friction component |
| T_{mDε0} | Motor torque direct constant acceleration |
| | component |
| T_{mA} | Motor torque alternating component |
| α₁ | Rotor or drum angle 1 |

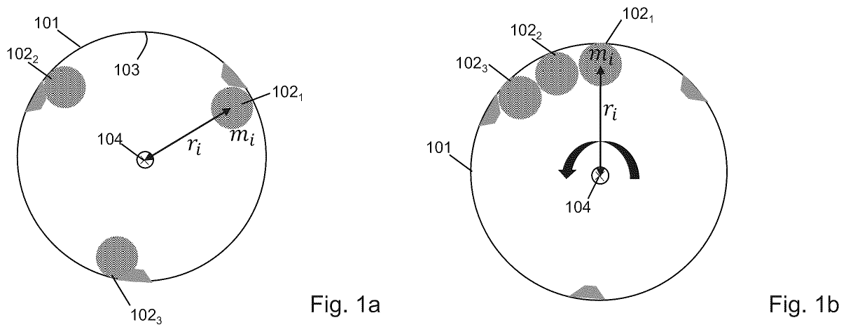

FIG. 1a is a schematic diagram illustrating an example washer drum 101 with a balanced load comprising a plurality of load portions 1021-3 evenly positioned around an inner surface 103 of the drum 101, each load portion having a mass mᵢ, with the centre of each mass 1021-3 located at a radius rᵢ. from a rotational axis 104 of the drum 101. In a typical washer drum, the rotational axis 104 is oriented substantially horizontally in operation so that the load portions 1021-3 are effectively forced against the inner surface 103 of the drum 101 when the drum 101 is rotated at a sufficiently high rotational speed.

FIG. 1b illustrates the washer drum 101 having an unbalanced load, with the load portions 102₁₋₃ instead unevenly positioned around the inner surface 103 of the drum 101, in this example with the load portions 102₁₋₃ bunched closely together. As the drum 101 rotates, this results in an unbalanced load on the rotational axis 104.

The balanced and unbalanced load may be represented by a balanced mass m_{balanced}, which is the mass that is equally distributed around the rotational axis 104 of the drum 101, and an unbalanced mass Δm_{unbalanced}, which is the part of the mass that is not balanced around the rotational axis 104.

With gravitational acceleration g and a drum radius r, the force acting on the drum 101 by each mass m is affected by the centrifugal force Fc and the gravitational force F_{g}. A minimum speed speedₘᵢₙ may be defined where each load having a mass m remains on the inner surface 103 of the drum 101 due to centrifugal force, the centrifugal force defined as:

$${F}_{c} = m {ω}^{2} r > {F}_{g} = mg \qquad Equation 1$$

where ω is the rotational speed (in rad/s) of the drum 101. The minimum speed, in rpm, can then be defined as:

$${speed}_{min} = \frac{60}{2 π} \sqrt{\frac{g}{r}} \qquad Equation 2$$

When the rotational speed of the drum 101 is greater than this minimum speed, the load inside the drum will stay on the inner surface 103.

The weight dynamics of the rotating system can be described with a mechanical inertia J, which is calculated from a sum of all mass elements mᵢ, each at a radius rᵢ from the rotating axis, in which:

$$J = {\sum }_{i = 1}^{N} {m}_{i} \cdot {r}_{i}^{2} \qquad Equation 3$$

This can be recalculated as one imaginary balanced weight mᵣ at a radius r from the rotational axis 104 of the drum 101, simplifying Equation 3 to:

$$J = {m}_{r} \cdot {r}^{2} \qquad Equation 4$$

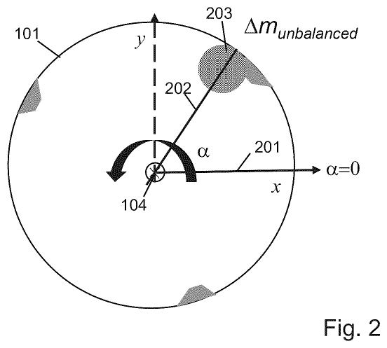

In the following, the balanced mass will be simply represented by m, while the unbalanced mass will be represented by Δm_{unbalanced}, or simply Δm. This is illustrated schematically in FIG. 2.

Washer drums are typically designed such that that there is a stable rotational speed region slightly above speedₘᵢₙ, so the calculations can be simplified with a stable drum axis. When the drum axis 104 is stable, the drum unbalanced mass (with a horizontal rotational axis 104) can be described with a gravitation response torque T_{g} as:

$${T}_{g} = \vec{g} X \sum {m}_{i} \vec{{r}_{ι}} \qquad Equation 5$$

This may be simplified using the equivalent unbalanced mass Δm_{unbalanced} as:

$${T}_{g} = - g \cdot Δ {m}_{unbalanced} \cdot cos ( α ) \qquad Equation 6$$

where α is the angle between the horizontal axis x 201 orthogonal to the rotational axis 104 and a radius 202 from the horizontal axis 104 to the centre of the unbalanced mass 203.

In following, the unbalanced mass is simplified to Δm≡Δm_{unbalanced}.

When the drum 101 is driven with a motor, the torque acting on the motor can be expressed as a sum of torque components:

$${T}_{d} + {T}_{g} + {T}_{f} = {T}_{m} \qquad Equation 7$$

where T_{d} is the dynamic torque, T_{g} is the gravitational torque T_{f} is the friction torque, and Tₘ the total motor torque.

For an angular acceleration ε, the dynamic torque T_{d} can be expressed as:

$$J \cdot ε = - Δ m \cdot r \cdot g \cdot cos ( α ) - {T}_{f} + {T}_{m} \qquad Equation 8$$

Defining drum (or rotor) position angles α₁, α₂, α₃:

$${α}_{2} = {α}_{1} + 180 ° \qquad Equation 9$$

$${α}_{3} = {α}_{1} + 360 °$$

The direct motor torque T_{mD} can be defined as:

$${T}_{mD} = \frac{1}{{Δ}_{( {α}_{1} {α}_{3} )} t} {\int }_{{t}_{α 1}}^{{t}_{α 3}} {T}_{m} dt = {T}_{mD ε 0} + {T}_{mDf} \qquad Equation 10$$

The alternating motor torque T_{mA} can be defined as:

$${T}_{mA} = {T}_{m} - {T}_{mD} \qquad Equation 11$$

The motor torque Tₘ may be split into direct acceleration torque T_{mDε} and alternating acceleration torque T_{mAε} with a friction compensation component T_{mf}, such that:

$${T}_{m} = {T}_{mA ε} + {T}_{mD ε} + {T}_{mf} \qquad Equation 12$$

For constant ε₀ and alternating ε_{A} accelerations:

$$J \cdot {ε}_{A} + J \cdot {ε}_{0} = - Δ m \cdot r \cdot g \cdot cos ( α ) + {T}_{mA ε} - {T}_{f} + {T}_{mf} + {T}_{mD ε} \qquad Equation 13$$

The motor friction compensation torque T_{mf} is equal to the friction torque T_{f}, i.e.:

$$0 = - {T}_{f} + {T}_{mf} \qquad Equation 14$$

At constant acceleration ε₀ a direct acceleration torque T_{mDε0} may be defined as:

$$J \cdot {ε}_{0} = {T}_{mD ε 0} \qquad Equation 15$$

For the direct friction compensation motor torque T_{mDf}:

$${\int }_{{α}_{1}}^{{α}_{3}} {T}_{f} = {\int }_{{α}_{1}}^{{α}_{3}} {T}_{mf} dt = {\int }_{{α}_{1}}^{{α}_{3}} {T}_{mDf} dt \qquad Equation 16$$

For the constant acceleration speed difference caused by the direct torque component:

$$J \cdot {Δ}_{( {α}_{1} {α}_{3} )} {ω}_{D ε 0} = {\int }_{{α}_{1}}^{{α}_{3}} {T}_{mD ε 0} dt \qquad Equation 17$$

$$J \cdot {Δ}_{360} {ω}_{D ε 0} ≅ {\int }_{{α}_{1}}^{{α}_{1} + 360} {T}_{mD ε 0} dt$$

From Equations 17, 16 and 10, for a 360 degree interval:

$$J \cdot {Δ}_{( {α}_{1} {α}_{3} )} {ω}_{D ε 0} = {\int }_{{α}_{1}}^{{α}_{3}} {T}_{mD ε 0} dt ≅ {\int }_{{α}_{1}}^{{α}_{3}} ( {T}_{mD} - {T}_{mDf} ) dt = {\int }_{{α}_{1}}^{{α}_{3}} ( {T}_{m} - {T}_{mDf} ) dt \qquad Equation 18$$

The speed difference Δ_{(α}_{₂}_{α}_{₃}₎ω between the drum (or rotor) position angles α₂ and α₃ may be defined as:

$${Δ}_{( {α}_{2} {α}_{3} )} ω = {ω}_{α 3} - {ω}_{α 2} \qquad Equation 19$$

The time difference Δ_{(α}_{₂}_{α}_{₃}₎t of spinning the drum between the two position angles α₂ and α₃ may be defined as:

$${Δ}_{( {α}_{2} {α}_{3} )} t = {t}_{α 3} - {t}_{α 2} \qquad Equation 20$$

Defining the drum (or rotor) rotation angles α₁, α₂, α₃ with α₂ between α₁ and α₃:

$${Δ}_{( {α}_{2} {α}_{3} )} t = \frac{1}{2} \cdot {Δ}_{( {α}_{1} {α}_{3} )} t \qquad Equation 21$$

At an angular speed with a low variation around a speed ω₀:

$${Δ}_{( {α}_{2} {α}_{3} )} {ω}_{ε 0} ≅ \frac{1}{2} \cdot {Δ}_{( {α}_{1} {α}_{3} )} {ω}_{ε 0} \qquad Equation 22$$

The motor torque Tₘ is usually a function of the motor input current vector, I, i.e.:

$${T}_{m} = f ( I ) \qquad Equation 23$$

When the friction position dependence is either constant or periodic with a period of Δ_{(α}_{₂}_{α}_{₃}₎t, from Equations 11, 12, 14 and 16 the alternating acceleration components T_{mAε} can be expressed as:

$${T}_{mA ε} ≅ {T}_{m} - {T}_{mD ε} - {T}_{mDf} = {T}_{m} - {T}_{m D} = {T}_{m A} \qquad Equation 24$$

Based on Equations 13, 14, 15, 17 and 24, we can integrate to obtain the relationship:

$$J \cdot {ε}_{A} \cdot \frac{d α}{d α} d t ≅ - Δ m \cdot r \cdot g \cdot cos ( α ) \frac{d α}{d α} d t + {T}_{m A} \frac{d α}{d α} d t \qquad Equation 25$$

When the drum (or rotor) angular speed variation is low compared to the angular speed, we can use ω₀, resulting in the following:

$$J \cdot {ε}_{A} d t ≅ - Δ m \cdot r \cdot g \cdot cos ( α ) \cdot \frac{1}{{ω}_{0}} d α + {T}_{m A} d t \qquad Equation 26$$

After integration between defined position angles α₁ and α₂:

$$J \cdot {Δ}_{( {α}_{1} {α}_{2} )} {ω}_{A} ≅ - Δ m \cdot r \cdot g \cdot \frac{1}{{ω}_{0}} ( sin ( {α}_{3} ) - sin ( {α}_{2} ) ) + {\int }_{{α}_{2}}^{{α}_{3}} {T}_{m A} d t \qquad Equation 27$$

For the alternating part of the angular speed difference:

$$Δ m \cdot r \cdot g \cdot \frac{1}{{ω}_{0}} ( sin ( {α}_{3} ) - sin ( {α}_{2} ) ) ≅ - J \cdot {Δ}_{( {α}_{2} {α}_{3} )} {ω}_{A} + {\int }_{{α}_{2}}^{{α}_{3}} {T}_{m A} d t \qquad Equation 28$$

When using the angular difference of constant acceleration

$${Δ}_{( {α}_{1} {α}_{2} )} {ω}_{ε 0} ≅ \frac{1}{2} \cdot {Δ}_{( {α}_{1} {α}_{3} )} {ω}_{ε 0}$$

from Equation 22:

$$J \cdot {Δ}_{( {α}_{2} {α}_{3} )} {ω}_{A} = J \cdot ( {Δ}_{( {α}_{2} {α}_{3} )} ω - \frac{1}{2} \cdot {Δ}_{( {α}_{1} {α}_{3} )} {ω}_{D ε 0} ) \qquad Equation 29$$

From Equations 28, 29 and 12:

$$Δ m \cdot r \cdot g \cdot \frac{1}{{ω}_{0}} ( sin ( {α}_{3} ) - sin ( {α}_{2} ) ) ≅ - J \cdot ( {Δ}_{( {α}_{2} {α}_{3} )} ω - \frac{1}{2} \cdot {Δ}_{( {α}_{1} {α}_{3} )} {ω}_{D ε 0} ) + {\int }_{{α}_{2}}^{{α}_{3}} ( {T}_{m} - {T}_{m D} ) d t \qquad Equation 30$$

The difference between the sine of angle α₃ and angle α₂, Δ_{(α}_{₂}_{α}_{₃}₎Sin can be defined as:

$${Δ}_{( {α}_{2} {α}_{3} )} Sin = sin ( {α}_{3} ) - sin ( {α}_{2} ) \qquad Equation 31$$

When appropriate drum (or rotor) position angle intervals are used, a minimum sine function difference can be defined as the following:

$$min ( sin ( {α}_{3} ) - sin ( {α}_{2} ) ) = - 2 ⇔ {α}_{2} = \frac{π}{2} = 90 deg , {α}_{3} = \frac{3 π}{2} = - \frac{π}{2} = - 90 deg \qquad Equation 32$$

A corresponding maximum sine function difference can be defined as:

$$max ( sin ( {α}_{3} ) - sin ( {α}_{2} ) ) = 2 ⇔ {α}_{2} = - \frac{π}{2} = - 90 deg , {α}_{3} = \frac{π}{2} = 90 deg \qquad Equation 33$$

Or a zero function:

$$0 = ( sin ( {α}_{3} ) - sin ( {α}_{1} ) ) ⇔ {α}_{1} = - \frac{π}{2} = - 90 deg , {α}_{3} = \frac{3 π}{2} = - \frac{π}{2} = - 90 deg \qquad Equation 34$$

For the alternating part of the angular speed difference, the optimum sensitivity and the maximum/minimum value of Equation 30 is when, according to Equations 32 and 33:

$${Δ}_{( - 90 , 90 )} = Sin = 2 \qquad Equation 35$$

$$or$$

$${Δ}_{( 90 , - 90 )} = Sin = - 2$$

The physical meaning of Equation 34 is that only the constant acceleration component Δ_{(α}_{₁}_{α}_{₃}₎ω_{Dε0} results from one drum rotation, i.e. integrating the dynamic torque expressed in Equation 8 over one complete rotation results in Equation 18.

From integrating intervals between drum (or rotor) angles α₂ and α₃, we can define time discrete sum functions as follows:

$${Int}_{TA α 2 α 3} = {\int }_{t {α}_{2}}^{t {α}_{3}} {T}_{m A} ( t ) dt ≅ {t}_{s} {\sum }_{n {α}_{2}}^{n {α}_{3}} {T}_{m A} ( n ) = {t}_{s} \cdot {S}_{TA α 2 α 3} \qquad Equation 36$$

### Balanced Mass Measurement Method 1

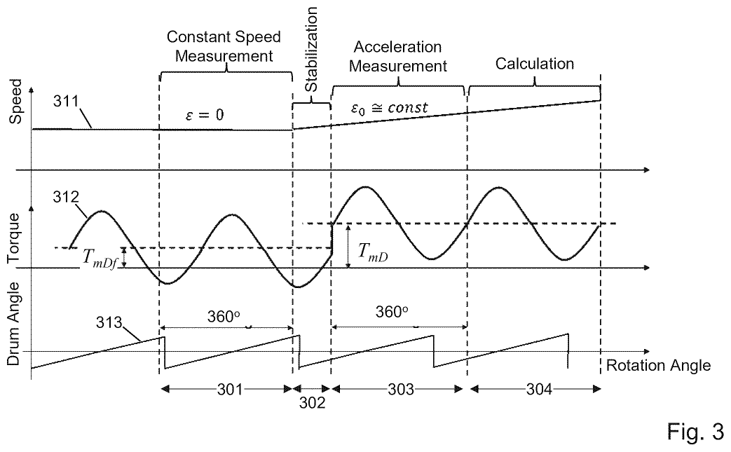

A plot illustrating an example first balanced mass measurement process is shown in FIG. 3. This indicates measurements of speed 311, torque 312 and drum angle 313. The process to determine the balanced mass comprises two steps. A first step involves a constant speed measurement with zero acceleration over a first time period 301 covering a complete drum rotation, i.e. a rotation of 360°. This measurement is then used to determine an average friction torque \tilde{T}_{mDf}=T_{AVG0}. In a second step, which optionally follows a stabilization period 302 during which the constant speed control in the first time period 301 is switched to constant acceleration control, in a second time period 303 the drum is driven over another complete drum rotation to obtain a constant acceleration, i.e. ε₀=const, while measuring the torque provided. This results in an average direct torque \tilde{T}_{mD}=T_{AVG}.

From Equation 17 and for discrete operation with a sampling time tₛ, i.e. the time between successive samples:

$$J \cdot {Δ}_{360} {ω}_{ε 0} ≅ {t}_{s} \cdot {S}_{360 TmD {ε0}_{1}} \qquad Equation 37$$

The average torque T_{AVG} can be calculated from motor torque samples Tn over a 360 degree drum (rotor) rotation with N₃₆₀ samples, such that:

$${T}_{AVG} = \frac{{\sum }_{n ( {α}_{1} )}^{n ( {α}_{1} + 360 )} {T}_{n}}{{N}_{360}} = \frac{{S}_{360 T}}{{N}_{360}} \qquad Equation 38$$

The average torque T_{AVG} is approximately equal to the friction torque component T_{mDf} plus a constant acceleration torque T_{mDε0}, i.e.:

$${T}_{AVG} ≅ {T}_{m D} = {T}_{mDf} + {T}_{mD ε 0} \qquad Equation 39$$

During the zero acceleration measurement phase in the first time period 301, in which the rotational speed is kept constant, the acceleration torque is zero, i.e.:

$${T}_{mD ε 0} = 0 \qquad Equation 40$$

The average torque at zero acceleration therefore approximately equals the average friction torque, i.e.:

$${T}_{AVG 0} ≅ {\tilde{T}}_{mDf} \qquad Equation 41$$

During the constant acceleration measurement phase over the second time period 303:

$${T}_{mD ε 0} = {T}_{m D} - {\tilde{T}}_{mDf} ≅ {T}_{AVG} - {T}_{AVG 0} \qquad Equation 42$$

The imaginary load inertia/as per Equation 4 above is given by J=mᵣ·r². From Equations 4 and 37, an estimate of the balanced mass m can be calculated as:

$$m ≅ \frac{{t}_{s}}{{r}^{2}} \cdot \frac{{S}_{360 Tmd ε {0}_{1}}}{{Δ}_{360} {ω}_{ε {0}_{1}}} \qquad Equation 43$$

where the torque sum over a 360° rotation, S_{360 Tmdε0}_{₁}, is based on Equation 42:

$${S}_{360 Td ε {0}_{1}} = {\sum }_{n ( {α}_{1} )}^{n ( {α}_{1} + 360 )} ( {T}_{n} - {T}_{AVG 0} ) \qquad Equation 44$$

The difference in rotational speed, Δ₃₆₀ω_{ε0}_{₁}, over the 360° rotation in the second time period 303, i.e. where the angle increases from α₁ to α₁+360 is given by:

$${Δ}_{360} {ω}_{ε 0} ≅ {ω}_{( α 1 + 360 )} - {ω}_{( a 1 )} \qquad Equation 45$$

The estimated balanced mass of the drum may then be calculated during a third time period 304 following the second time period 303.

### Unbalanced Mass Measurement and Balanced Mass Measurement Method 2

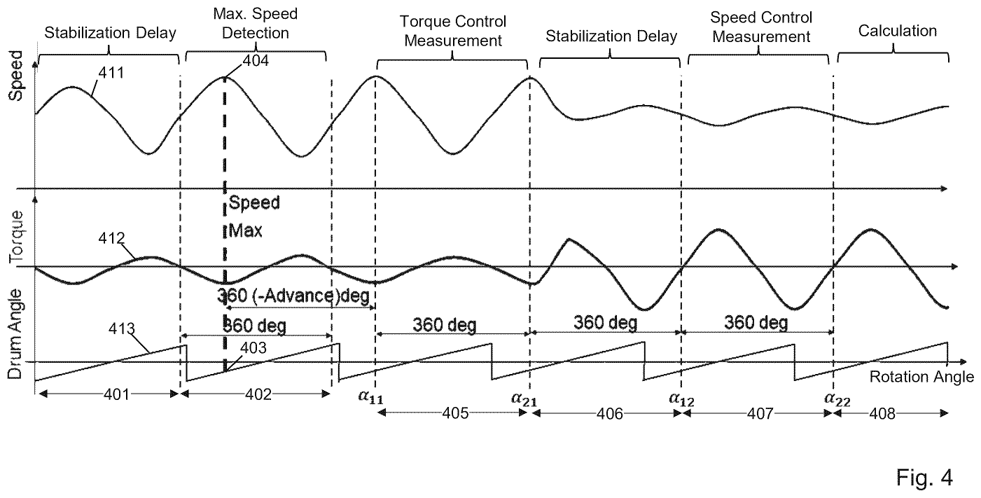

A plot illustrating an example procedure for determining an unbalanced mass of the drum is shown in FIG. 4, which shows measures of speed 411, torque 412 and drum angle position 413 as a function of time. In an initial optional stabilization time period 401, the motor is set for torque control and the speed cycle is stabilized for at least one rotation of the drum.

Following stabilization, over a first time period 402 the motor is controlled for constant torque and a rotational speed 411 of the drum and applied torque are measured over a complete 360° drum rotation. The angle 403 at which a maximum rotational speed 404 is detected is determined over the first time period 402. An offset drum position angle is then calculated based on the position angle of maximal detected speed 404. The next measurement sequence then starts when the position of the drum reaches the maximum detected speed angle plus the offset. The offset angle may be 360°, optionally minus an advance angle, i.e. the start of the next measurement sequence may be at a drum angle of a α_{ωmax}+360−α_{advanced}. In FIG. 4 this angle is indicated by α₁₁. During a second time period 405 starting from this angle, the motor is operated for constant torque and a torque control measurement cycle is carried out over a further complete rotation, i.e. a further 360° rotation. At the end of this second time period 405, the motor control is set to speed control. Following a further stabilization period 406, a speed control measurement is carried out over a third time period 407, which begins with the drum at the same offset drum position angle, indicated in FIG. 4 as α₁₂. The drum is then rotated over a complete rotation, i.e. a further 360° rotation, following which the unbalanced mass is calculated during a calculation period 408.

As depicted in FIG. 4, constant torque control during the second time period 405 results in a higher speed variation and a lower torque variation, while constant speed control in the third time period 407 results in a lower speed variation and a higher torque variation. Although the control in each time period 405, 407 is nominally controlling for a constant torque or speed, such control is in practice generally not realistically achievable and some variation in the parameter being controlled does occur. The measurement method described herein also covers this variation.

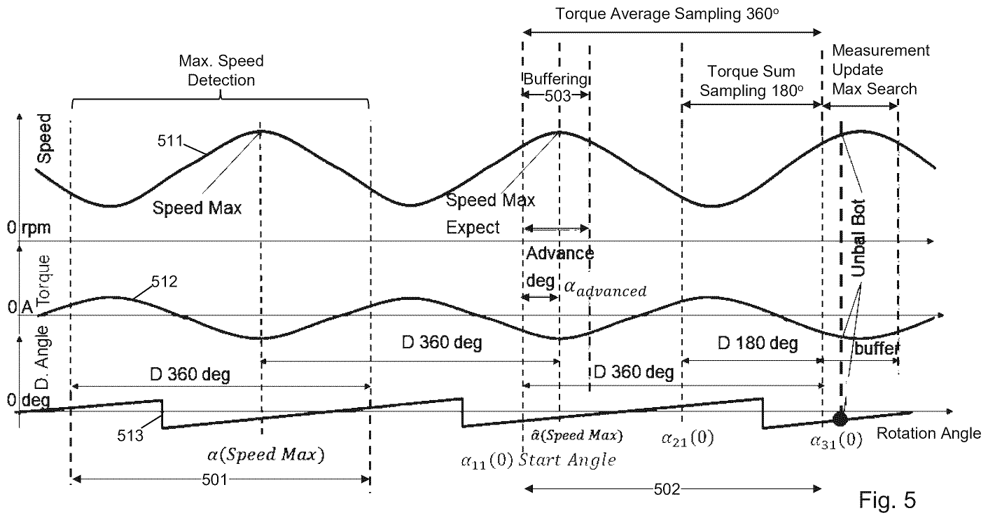

FIG. 5 illustrates an example sequence of operations showing a maximum speed detection, followed by a torque control measurement, following which the unbalanced mass is calculated. As with FIG. 4, speed 511, motor torque 512 and drum angle 513 are shown as a function of rotation angle.

During a first time period 501 covering a complete drum rotation, the drum is driven under constant torque control and an angle is determined at which a maximum speed is obtained. The maximum speed angle is then stored. A further measurement cycle is then started when the drum again reaches the maximum speed angle, optionally offset by an advance angle, i.e. when the drum reaches the angle α_{ωmax}+360−α_{advanced}. The advance angle may be determined based on Equation 66 below. A buffering period 503 after the start of a second time period 502 is determined by the number Nb of buffered samples and the angular speed. The buffering period 503 starts before the expected maximum speed in the second time period 502.

During the second time period 502, the torque is sampled over a further complete rotation of the drum, which includes a sampling period over a second half of the second time period 502 covering a 180° rotation of the drum.

During the time period 502, each torque sample is added to a S_{360T} sum, i.e. a sum of torque samples over the second time period covering a complete rotation of the drum, which is stored for later use.

After a 180 degrees of rotation, the torque sum 180 degree S_{180T} calculation and torque and rotor angular speed buffering starts, Each torque sample is add into the sum S_{180T}(n+1)=S_{180T}(n)+T(nₐ). and buffered T_{BUF}(α₍ₙ₎)=T(nₐ). Speed measurements are also buffered as ω_{BUF}(n)=ω(n(α)).

Torque and speed measurement buffering is provided during Nb samples, which determines the searching/buffering angle α. The buffered samples can then be used for a Maximal search state.

After the end of the second time period 502, the average torques over the second time period and the first approach of second half of the second time period are determined. The 360 degree torque sum S₃₆₀ is stored for an average torque calculation

Following the second time period 502, the torque sum over 180 degree S_{180T} is updated with new torque T(n) samples and the buffered samples T_{BUF}(α₍ₙ₎) from the beginning of the previous steps are subtracted according to Equation 68, i.e. S_{180Ta}(α₍ₖ₎)=S_{180Ta}(α₍ₖ₋₁₎)+(T(α₍ₖ₎)−T_{AVG}−T_{BUF}(α₍ₖ₎−180)).

The Equation 65 function (see below) maximum is searched and 180 degree the S_{180Ta}(α(k)) sum and Δ₁₈₀\hat{ω}_{εA}(αₖ) at the Equation 65 maximum are stored, to be used for final calculations. The search is provided at Nb of buffered samples. From FIG. 2 and Equation 6, it can be proved that the maximum of the function from Equation 65 will be at −90 degrees of the unbalanced weight position.

### Calculation of Unbalanced Mass

$${Int}_{180 Ta} = {Int}_{TAα 2 α 3} = {\int }_{{α}_{2}}^{{α}_{3}} {T}_{m A} d t = {\int }_{{α}_{2}}^{{α}_{3}} ( {T}_{m} - {T}_{m D} ) d t \qquad Equation 46$$

The sum of torque samples per angle from n(α₁+180) to n(α₁+360) which gives the alternating torque component:

$${S}_{180 Ta} = {S}_{TA α 2 α 3} = {\sum }_{n ( {α}_{1} + 180 )}^{n ( {α}_{1} + 360 )} ( T ( n ) - {T}_{A V G} ) = {\sum }_{n ( {α}_{1} + 180 )}^{n ( {α}_{1} + 360 )} ( T ( n ) - \frac{{N}_{180}}{{N}_{360}} \cdot {\sum }_{n ( {α}_{1} )}^{n ( {α}_{1} + 360 )} {T}_{n} \qquad Equation 47$$

$${S}_{360 T} = {\sum }_{n ( {α}_{1} )}^{n ( {α}_{1} + 360 )} T ( n ) \qquad Equation 48$$

$${S}_{180 T} = {\sum }_{n ( {α}_{1} + 180 )}^{n ( {α}_{1} + 360 )} T ( n ) \qquad Equation 49$$

The weight detection algorithm provides two measurements, a first under torque control and a second under speed control.

We can define position angles for torque α₁₁α₂₁ and speed α₁₂α₂₂ measurements as:

$${α}_{12} = {α}_{11} + k \cdot 360 \qquad Equation 50$$

$${α}_{22} = {α}_{21} + k \cdot 360$$

So the two measurements are made at the same drum (rotor) angular position plus a kₜₕ rotation.

Based on Equation 28 we can define

$${Δω}_{x} = {Δ}_{( {α}_{2 x} {α}_{3 x} )} {ω}_{A} ≅ {Δ}_{180} {\hat{ω}}_{ε A} \qquad Equation 51$$

$${ω}_{0 x} = {ω}_{0}$$

And for the Int_{TAα2xα3x} from Equation 36:

$${Int}_{TAx} = {Int}_{TA α 2 x α 3 x} \qquad Equation 52$$

$${S}_{TAx} = {S}_{TA α 2 x α 3 x}$$

$$Δ {Sin}_{x} = sin ( {α}_{3 x} ) - sin ( {α}_{2 x} ) \qquad Equation 53$$

Then for the two measurements under torque control and speed control:

$$B = r \cdot g ( sin {α}_{3} - sin {α}_{2} ) = r \cdot g \cdot Δ Sin \qquad Equation 54$$

$$Δ m \cdot {B}_{1} = - {ω}_{01} \cdot J \cdot {Δω}_{1} + {ω}_{01} \cdot {Int}_{TA 1}$$

$$Δ m \cdot {B}_{2} = - {ω}_{02} \cdot J \cdot {Δω}_{2} + {ω}_{02} \cdot {Int}_{TA 2}$$

Based on Equation 54, when Equation 52 ΔSin₁=ΔSin₂=ΔSin

$$Δ m \cdot {B}_{1} = Δ m \cdot {B}_{2} \qquad Equation 55$$

And so for load inertia

$$J = \frac{{ω}_{02} \cdot {Int}_{TA 2} - {ω}_{01} \cdot {Int}_{TA 1}}{{ω}_{02} \cdot Δ {ω}_{2} - {ω}_{01} \cdot Δ {ω}_{1}} \qquad Equation 56$$

And for the unbalanced mass:

$$Δ m = \frac{{ω}_{01} \cdot {ω}_{02}}{r \cdot g \cdot Δ Sin} \cdot \frac{{Δω}_{2} \cdot {Int}_{TA 1} - {Δω}_{1} \cdot {Int}_{TA 2}}{{ω}_{02} \cdot Δ {ω}_{2} - {ω}_{01} \cdot Δ {ω}_{1}} \qquad Equation 57$$

The measurement calculations are based on following formulas.

The angular speed difference between a 180 degree drum (rotor) position angle from α₁+180 to α₁+360 is given by:

$${Δ}_{180} {\hat{ω}}_{ε A} = {Δ}_{180} ω - \frac{1}{2} \cdot {Δ}_{360} {ω}_{ε 0} = {ω}_{( α 1 + 360 )} - {ω}_{( α 1 + 180 )} - \frac{1}{2} \cdot {Δ}_{360} {ω}_{ε 0} \qquad Equation 58$$

$$And so :$$

$${Δ}_{180} {\hat{ω}}_{ε A} = \frac{1}{2} \cdot {ω}_{( α 1 + 360 )} - {ω}_{( α 1 + 180 )} + \frac{1}{2} \cdot {ω}_{( α 1 )} \qquad Equation 59$$

The unbalanced mass Δm can thereby be calculated in the time discrete domain as:

$$Δ m = \frac{{t}_{s}}{r \cdot g \cdot Δ Sin} \cdot {ω}_{01} \cdot {ω}_{02} \cdot \frac{{Δ}_{180} {\hat{ω}}_{ε {A}_{2}} \cdot {S}_{180 {Ta}_{1}} - {Δ}_{180} {\hat{ω}}_{ε {A}_{1}} \cdot {S}_{180 {Ta}_{2}}}{{ω}_{02} \cdot {Δ}_{180} {\hat{ω}}_{ε {A}_{2}} - {ω}_{01} \cdot {Δ}_{180} {\hat{ω}}_{ε {A}_{1}}} \qquad Equation 60$$

as can be derived from Equation 57.

When ΔSin=−2 is substituted into Equation 56:

$$Δ m = \frac{{t}_{s}}{r \cdot g \cdot ( - 2 )} \cdot {ω}_{01} \cdot {ω}_{02} \cdot \frac{{Δ}_{180} {\hat{ω}}_{ε {A}_{2}} \cdot {S}_{180 {Ta}_{1}} - {Δ}_{180} {\hat{ω}}_{ε {A}_{1}} \cdot {S}_{180 {Ta}_{2}}}{{ω}_{02} \cdot {Δ}_{180} {\hat{ω}}_{ε {A}_{2}} - {ω}_{01} \cdot {Δ}_{180} {\hat{ω}}_{ε {A}_{1}}} \qquad Equation 61$$

When the rotation speeds ω₀₁, ω₀₂ are calculated within a 360° drum (rotor) rotation, α₁ₓ, φ₃ₓ=α₁ₓ+360:

$${ω}_{0 x} = \frac{2 \cdot π}{{t}_{s} \cdot Δ {N}_{360 x}} \qquad Equation 62$$

In a software implementation:

$$Δ m = \frac{- π}{r \cdot g} \cdot \frac{1}{Δ {N}_{360 \; 1}} \cdot \frac{1}{Δ {N}_{360 \; 2}} \cdot \frac{{Δ}_{180} {\hat{ω}}_{ε {A}_{2}} \cdot {S}_{180 {Ta}_{1}} - {Δ}_{180} {\hat{ω}}_{ε {A}_{1}} \cdot {S}_{180 {Ta}_{2}}}{\frac{1}{Δ {N}_{360 \; 2}} \cdot {Δ}_{180} {\hat{ω}}_{ε {A}_{2}} - \frac{1}{Δ {N}_{360 \; 1}} \cdot {Δ}_{180} {\hat{ω}}_{ε {A}_{1}} \cdot {S}_{180 {Ta}_{2}}} \qquad Equation 63$$

Due to ΔSin=−2 in Equation 61, searching the maximum of:

$$abs ( sin ( {α}_{2} ) - sin ( {α}_{1} ) ) = abs ( Δ Sin ) = 2 \qquad Equation 64$$

is necessary to determine a correct unbalanced load Δm.

Based on Equations 54, 64 and 36, the maximum of the iteration function

$$F ( k ) = abs ( {\hat{m}}_{est} \cdot {Δ}_{180} {\hat{ω}}_{ε A} ( {α}_{k} ) - \frac{{t}_{s}}{{r}^{2}} \cdot {S}_{180 Ta} ( {α}_{( k )} ) ) \qquad Equation 65$$

is searched over a defined number of Nb samples.

The searching angle α depends on the number Nb of samples and the angular speed. The searching starts at the advanced angle position before the periodical speed maximum.

$${α}_{advanced} = α ( Speed Max ) - {α}_{11} ( 0 ) = \frac{{N}_{b} \cdot {t}_{s} \cdot {ω}_{0 x}}{2} \qquad Equation 66$$

The torque and angular speed at the beginning of the 180 degree measurement is buffered with this defined number of samples Nb. At the end of the 180 degree measurement, the angular speed difference and torque sum are updated with the buffered samples, and new samples. When the F (k) maximum is evaluated, the Δω(αₖₘₐₓ) and S_{AC180}(α₍ₖₘₐₓ₎₎. This way the abs(ΔSin)=2 is obtained.

The angular speed difference between 180 degree angle iteration:

$${Δ}_{180} {\hat{ω}}_{ε A} ( {α}_{k} ) = ω ( {α}_{k} ) - {ω}_{BUF} ( {α}_{k} - 180 ) - \frac{1}{2} \cdot ( {ω}_{( α 1 + 360 )} - {ω}_{( α 1 )} ) \qquad Equation 67$$

The torque sum difference between 180 degree angle iterations is given by:

$${S}_{180 Ta} ( {α}_{( k )} ) = {S}_{180 Ta} ( {α}_{( k - 1 )} ) + ( T ( {α}_{( k )} ) - {T}_{AVG} - {T}_{BUF} ( {α}_{k} - 180 ) ) \qquad Equation 68$$

### Balanced Mass Calculation: Method 2 (Alternative)

As can be derived from Equation 56:

$$m = \frac{{t}_{s}}{{r}^{2}} \cdot \frac{{ω}_{02} \cdot {S}_{180 {Ta}_{2}} - {ω}_{01} \cdot {S}_{180 {Ta}_{1}}}{{ω}_{02} \cdot {Δ}_{180} {\hat{ω}}_{ε {A}_{2}} - {ω}_{01} \cdot {Δ}_{180} {\hat{ω}}_{ε {A}_{1}}} \qquad Equation 69$$

Therefore, based on the unbalanced load process it is also possible to calculate the balanced load. The precision of this method is, however, dependent on Δm. When Δm is too small, the balanced load based on Equation 69 is less precise. The first method may, however, be used to determine the balanced load instead.

A software implementation in the time discrete domain is given as:

$$m = \frac{{t}_{s}}{{r}^{2}} \cdot \frac{\frac{1}{Δ {N}_{360 \_ 2}} \cdot {S}_{180 {Ta}_{2}} - \frac{1}{Δ {N}_{360 \_ 1}} \cdot {S}_{180 {Ta}_{1}}}{\frac{1}{Δ {N}_{360 \_ 2}} \cdot {Δ}_{180} {\hat{ω}}_{ε {A}_{2}} - \frac{1}{Δ {N}_{360 \_ 1}} \cdot {Δ}_{180} {\hat{ω}}_{ε {A}_{1}}} \qquad Equation 70$$

### Torque Calculation

In the case of an electronic motor controller it is straightforward to calculate motor torque based on measured motor current, i.e.:

$${T}_{m} = f ( I )$$

### Equation 71

In the example case of field oriented control of a PMS motor, the torque is almost linear with the torque rotating current component, i.e.:

$${T}_{m} = const \cdot {I}_{q} \qquad Equation 72$$

### Balanced and Unbalanced Mass Measurement: State Machines

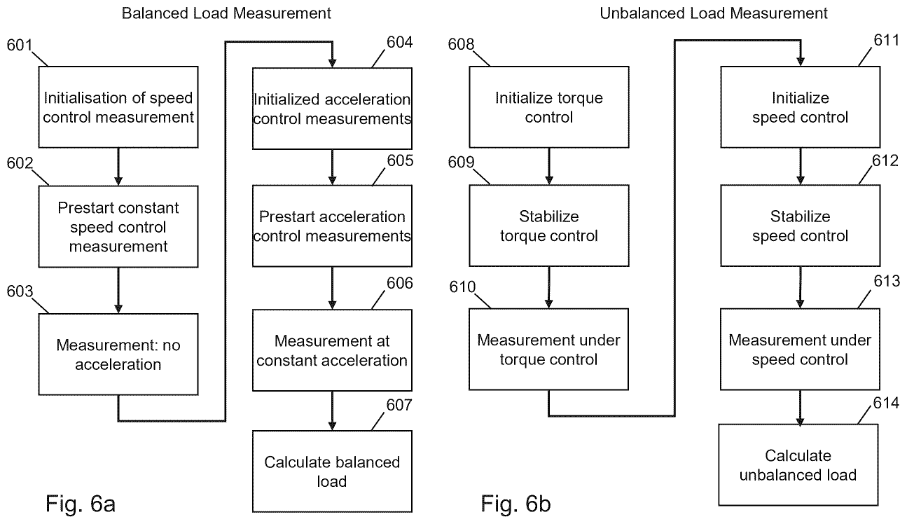

FIG. 6a illustrates a schematic flow diagram illustrating an example state machine representing a computer-implemented method of estimating a balanced load encompassing the balanced load measurement method described above, as performed by a motor controller. A schematic flow diagram illustrating an example state machine representing a computer-implemented method of establishing an unbalanced load encompassing the unbalanced load measurement method described above is depicted in FIG. 6b. The process in FIG. 6a may be followed by the process in FIG. 6b, i.e. with step 608 following directly after step 607. The processes may alternatively be performed separately or in reverse order.

For measuring the balanced load, the process starts at step 601 with initialising a constant speed control measurement. Once this step is completed, at step 602 a stabilisation step is performed, followed by at step 603 a constant speed control measurement, for example according to the example shown in FIG. 3 in the first time period 301, which results in a measure of torque at no acceleration, T_{AVG0}, calculated according to Equation 38 Once this measurement is completed, at step 604 an acceleration control measurement is initialised and, following a stabilisation period at step 605, corresponding to the second time period 302 in FIG. 3, a measurement at constant acceleration is performed, corresponding to the third time period 303 in FIG. 3, resulting in a measure of average torque T_{AVG} under constant acceleration. At step 607, a balanced load m (\hat{m}ₑₛₜ) calculated based on Equations 43, 44 and 45.

For measuring the unbalanced load, the process according to that described above with reference to FIGS. 4 and 5 starts at step 608 with initialising a constant torque control setting, followed in step 609 by a stabilisation period. A measurement under torque control is then carried out at step 610. At step 611 speed control is initialised and stabilised at step 612. A measurement is then carried out under speed control at step 613, followed by calculations of the unbalanced load.

At the start of this process, S_{360T}N_{360T}, S_{180T}N_{180T} are initialized to 0. After a stabilisation delay (step 609), the speed minimum and maximum are searched and α(Speed Max) is stored. A measurement under constant torque control is then carried out (step 610). The start angle α₁₁(0) for this is searched based on Equation 65. During the Sum360 state, the S_{360T} iterations are calculated based on Equation 47 and N_{360T} is incremented with a sampling period tₛ. In the Sum360, Sum180 state, the S_{360T} iterations and N_{360T} increments are provided together with S_{180T} iterations based on Equation 49 with N_{180T} increments. The angular speed ω_{BUF}(αₖ−180) and torque T_{BUF}(αₖ−180) are buffered (for future maximum search) after reaching an interval of 360 degree from α₁₁(0), then Δω and S_{AC180} are calculated. The measurements of Δω and S_{AC180} are updated with a maximum search according to Equation 66. Equation 65 is provided when \hat{m}ₑₛₜ from the balanced load measurement process is used. The speed difference is updated such that

$${Δ}_{180} {\hat{ω}}_{ε A} ( {α}_{k} ) = ω ( {α}_{k} ) - {ω}_{BUF} ( {α}_{k} - 180 ) - \frac{1}{2} \cdot ( {ω}_{( α 1 + 360 )} - {ω}_{( α 1 )} ) ,$$

according to Equation 67 and the sum S_{180Ta}(α₍ₖ₎)=S_{180Ta}(α₍ₖ₋₁₎)+(T(α₍ₖ₎)−T_{AVG}−T_{BUF}(α₍ₖ₎−180)) according to Equation 68 with actual and previously buffered samples until the buffer ends. The Δω(αₖ) and S_{AC180}(α₍ₖ₎) for index k according to Equation 65 F(k)=max is stored for final calculations. This is also depicted in FIG. 5. Final ΔN_{360 1} S_{180 Tac1} and Δ₁₈₀\hat{ω}_{εAC1} are calculated and memorized based on Equations 59 and 47. The Δ₁₈₀\hat{ω}_{εAC1}=Δω and S_{180 Tac1}=S_{AC180} are calculated and ΔN_{360 1}=ΔN₃₆₀ is stored. The Start Angle α₂₁(0) is set and then the constant speed control (steps 611-613) is executed according to the process described above. First, S_{360T}N_{360T}, S_{180T}N_{180T} are initialized to 0 (step 611). After a stabilization delay (step 612), measurement under speed control (step 613) is executed. The Start Angle α₂₁(0) is searched based on Equation 65. During the Sum360 state, the S_{360T} iterations are calculated based on Equation 47 and N_{360T} incremented with a sampling period tₛ.

In the Sum360, Sum180 state, the S_{360T} iterations and N_{360T} increments are provided together with S_{180T} iteration based on Equation 49 with N_{180T} increments. After a 360 degree interval from α₁₁(0) is reached, the Δ₁₈₀\hat{ω}_{εAC2}=Δω and S_{180 Tac2}=S_{AC180} are calculated and ΔN_{360 2}=ΔN₃₆₀ Finally, calculation of the unbalanced load Δm is provided from ΔN_{360 1}, ΔN_{360 2}S_{180 Tac1}, S_{180 Tac2}, Δ₁₈₀\hat{ω}_{εAC1} and Δ₁₈₀\hat{ω}_{εAC2} based on Equation 63. If the second method for calculating the balanced load is used, the balanced load can then be calculated based on Equation 70.

This process described herein is primary designed for use in a motor controller for a washing machine. The torque necessary for the sampling process may be derived based on Equations 71 and 72, i.e. that the motor torque Tₘ, is a function of motor current and that the function is generally a linear relationship. The motor current may therefore be sampled to determine the motor torque. The position and speed information may be provided using a sensor such as an encoder or other type of absolute position sensor on the rotor. Instead of using an encoder or position sensor, the speed can alternatively be estimated using a sensorless algorithm which estimates the speed based on phase current and voltages quantities. The speed estimation bandwidth needs to be sufficiently fast, so that the measured speed and any errors are below the speed variations caused by the unbalanced load.

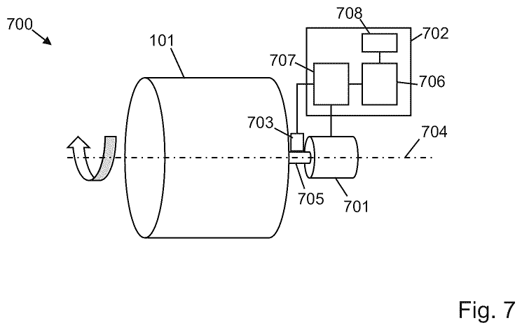

FIG. 7 is a schematic drawing of an assembly 700, which may form part of a washing machine, the assembly 700 comprising a drum 101 connected to be driven about a horizontal axis 704 by an electric motor 701. The electric motor 701 is controlled by a motor controller 702, which provides drive signals to the motor 701 and receives or determines a torque measurement on the rotor shaft 705. As described above, the torque may be determined from a measure of current through the motor 701 or may be measured by a torque sensor in the motor 701. A rotational sensor 703 may be provided on the rotor shaft 705 to measure the angular position and rotational speed of the rotor shaft 705.

The motor controller 702 comprises a processor 706, input/output (I/O) interface 707 and memory 708. The I/O interface provides a drive signal to the motor 701 and receives information from the motor 701 and rotational sensor 703. The processor 706 processes signals received from and generates drive signals for the motor 701. The memory 708 is used for storing information and instructions for operating the controller 702.

The process described herein performs integration of the motor torque applied in one revolution of a mechanical system (which may be a washing machine drum or more generally a rotor of an electric motor) and calculates average torque in one mechanical revolution (i.e. over 360 degrees of rotation) and alternating torque over 180 degrees. Based on measurements carried out under torque control and speed control, an unbalanced load and a balanced load can be calculated.

Unbalanced load detection is an important factor particularly for washing machine control but may also apply to other rotary device applications having unbalanced loads. The process described herein optimizes for cost of the overall solution by not requiring additional sensors (e.g. an accelerometer) for detecting an unbalanced load condition. Instead, electrical signals are used that are normally available in the system and used by the motor control system for driving a motor.

From reading the present disclosure, other variations and modifications will be apparent to the skilled person. Such variations and modifications may involve equivalent and other features which are already known in the art of rotary machine control systems, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A method of estimating loads in a rotary machine comprising a drum containing a plurality of load portions and driven for rotation about a rotation axis by a motor, the method comprising:
estimating an unbalanced load by:
i) measuring a rotational speed of the drum during a first time period over a first complete rotation of the drum while the motor is driven under constant torque control;
ii) determining a maximum speed angle during the first time period as a rotational angle of the drum over the first time period at which the rotational speed of the drum is a maximum;
iii) measuring torque and rotational speed during a second time period over a second complete rotation of the drum starting at the maximum speed angle offset by a predetermined advance angle while the motor is driven under constant torque control; and
iv) calculating an estimated unbalanced load of the drum from measurements of torque and rotational speed over the second time period and a difference in rotational speed over first and second halves of the second time period.

2. The method of claim 1, wherein the estimated unbalanced load Δm is calculated from:
$$Δ m = \frac{{t}_{s}}{r \cdot g \cdot ( - 2 )} \cdot {ω}_{01} \cdot {ω}_{02} \cdot \frac{{Δ}_{180} {\hat{ω}}_{ε {A}_{2}} \cdot {S}_{180 {Ta}_{1}} - {Δ}_{180} {\hat{ω}}_{ε {A}_{1}} \cdot {S}_{180 {Ta}_{2}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$
where tₛ is a measurement sampling period, r is a radius of the drum, g is a gravitational acceleration, ω₀₁ is a rotational speed at the start of the second time period, ω₀₂ is a rotational speed at the end of the second time period, S_{180Ta}_{₁} is a sum of torque samples over the first half of the second time period, S_{180Ta}_{₂} is a sum of torque samples over the second half of the second time period, Δ₁₈₀\hat{ω}_{εA}_{₁} is a difference in rotational speed over the first half of the second time period and Δ₁₈₀\hat{ω}_{εA}_{₂} is a difference in rotational speed over the second half of the second time period.

3. The method of claim 2, wherein the predetermined advance angle α_{advanced} is calculated as:
$${α}_{advanced} = α ( Speed Max ) - {α}_{11} ( 0 ) = \frac{{N}_{b} \cdot {t}_{s} \cdot {ω}_{0 x}}{2}$$
where α(Speed Max) is the maximum speed angle, α₁₁(0) is the rotation angle at the start of the second time period, N_{b} is a number of samples over the first half of the second time period, ω₀ₓ is the rotational speed at the start of the second time period.

4. The method of claim 1, further comprising calculating an estimated balanced load m from:
$$m = \frac{{t}_{s}}{{r}^{2}} \cdot \frac{{ω}_{02} \cdot {S}_{180 {Ta}_{2}} - {ω}_{01} \cdot {S}_{180 {Ta}_{1}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$

5. The method of claim 1, further comprising calculating an estimated balanced load by:
i) measuring a torque during a third time period over a third complete rotation of the drum (101) while the motor is driven under constant speed control to determine an average friction torque;
ii) measuring the torque and a rotation speed of the drum during a fourth time period over a fourth complete rotation of the drum while the motor is driven under constant acceleration control to determine an average acceleration torque;
iii) subtracting the average friction torque from the average acceleration torque to obtain a corrected average acceleration torque; and
iv) calculating the estimated balanced load of the drum from the corrected acceleration torque, a difference in rotation speed over the second time period and a radius of the drum.

6. The method of claim 5, wherein the estimated balanced load m of the drum is calculated from:
$$m ≅ \frac{{t}_{s}}{{r}^{2}} \cdot \frac{{S}_{360 Tmd ε {0}_{1}}}{{Δ}_{360} {ω}_{ε {0}_{1}}}$$
where tₛ is a measurement sampling period, r is the radius of the drum, S_{360 Tmdε0}_{₁} is a sum of measured torque samples over the fourth time period and Δ₃₆₀ω_{ε0}_{₁} is the difference in rotation speed over the fourth time period.

7. The method of claim 1, wherein measuring the torque comprises measuring an electric current through the motor and converting the measured electric current to a measure of torque.

8. The method of claim 7, wherein the rotational speed and position are derived from a rotational sensor on the rotor.

9. A motor controller for a rotary machine comprising a drum for containing a plurality of load portions driven for rotation about a rotation axis by a motor, the motor controller being configured to estimate an unbalanced load on the drum by:
i) measuring a rotational speed of the drum during a first time period over a first complete rotation of the drum while the motor is driven under constant torque control;
ii) determining a maximum speed angle during the first time period as a rotational angle of the drum over the first time period at which the rotational speed of the drum is a maximum;
iii) measuring torque and rotational speed during a second time period over a second complete rotation of the drum starting at the maximum speed angle offset by a predetermined advance angle while the motor is driven under constant torque control; and
iv) calculating an estimated unbalanced load of the drum from measurements of torque and rotational speed over the second time period and a difference in rotational speed over first and second halves of the second time period.

10. The motor controller of claim 9, wherein the estimated unbalanced load Δm is calculated from:
$$Δ m = \frac{{t}_{s}}{r \cdot g \cdot ( - 2 )} \cdot {ω}_{01} \cdot {ω}_{02} \cdot \frac{{Δ}_{180} {\hat{ω}}_{ε {A}_{2}} \cdot {S}_{180 {Ta}_{1}} - {Δ}_{180} {\hat{ω}}_{ε {A}_{1}} \cdot {S}_{180 {Ta}_{2}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$
where tₛ is a measurement sampling period, r is a radius of the drum, g is a gravitational acceleration, ω₀₁ is a rotational speed at the start of the second time period, ω₀₂ is a rotational speed at the end of the second time period, S_{180Ta}_{₁} is a sum of torque samples over the first half of the second time period, S_{180Ta}_{₂} is a sum of torque samples over the second half of the second time period, Δ₁₈₀\hat{ω}_{εA}_{₁} is a difference in rotational speed over the first half of the second time period and Δ₁₈₀\hat{ω}_{εA}_{₂} is a difference in rotational speed over the second half of the second time period.

11. The motor controller of claim 10, wherein the predetermined advance angle α_{advanced} is calculated as:
$${α}_{advanced} = α ( Speed Max ) - {α}_{11} ( 0 ) = \frac{{N}_{b} \cdot {t}_{s} \cdot {ω}_{0 x}}{2}$$
where α(Speed Max) is the maximum speed angle, α₁₁(0) is the rotation angle at the start of the second time period, N_{b} is a number of samples over the first half of the second time period, ω₀ₓ is the rotational speed at the start of the second time period.

12. The motor controller of claim 9, wherein the motor controller is further configured to calculate an estimated balanced load m from:
$$m = \frac{{t}_{s}}{{r}^{2}} \cdot \frac{{ω}_{02} \cdot {S}_{180 {Ta}_{2}} - {ω}_{01} \cdot {S}_{180 {Ta}_{1}}}{{ω}_{02} \cdot {Δ}_{180} {\hat{ω}}_{ε {A}_{2}} - {ω}_{01} \cdot {Δ}_{180} {\hat{ω}}_{ε {A}_{1}}}$$

13. The motor controller of claim 9, wherein the motor controller is further configured to calculate an estimated balanced load by:
i) measuring a torque during a third time period over a third complete rotation of the drum while the motor is driven under constant speed control to determine an average friction torque;
ii) measuring the torque and a rotation speed of the drum during a fourth time period over a fourth complete rotation of the drum while the motor is driven under constant acceleration control to determine an average acceleration torque;
iii) subtracting the average friction torque from the average acceleration torque to obtain a corrected average acceleration torque; and
iv) calculating the estimated balanced load of the drum from the corrected acceleration torque, a difference in rotation speed over the second time period and a radius of the drum.

14. The motor controller of claim 13, wherein the estimated balanced load m of the drum is calculated from:
$$m ≅ \frac{{t}_{s}}{{r}^{2}} \cdot \frac{{S}_{360 Tmd ε {0}_{1}}}{{Δ}_{360} {ω}_{ε {0}_{1}}}$$
where tₛ is a measurement sampling period, r is the radius of the drum, S_{360 Tmdε0}_{₁} is a sum of measured torque samples over the fourth time period and Δ₃₆₀ω_{ε0}_{₁} is the difference in rotation speed over the fourth time period.

15. A computer program comprising instructions for causing a motor controller for a rotary machine to perform the method according to claim 1.

16. The method of claim 7, wherein the torque is measured as a linear function of the measured electric current.
